(19) United States
(12) Patent Application Publication
(10) Pub. No.: US 2016/0236310 A1
(43) Pub. Date: Aug. 18, 2016

(54) MILLING APPARATUS FOR ALUMINIUM INGOTS

(71) Applicant: SMS Meer GmbH, Monchenglabach (DE)

(72) Inventors: Ulrich Riepling, Wedemark (DE); Karl DITTRICH, Moenchengladbach (DE)

(21) Appl. No.: 14/833,537

(22) Filed: Aug. 24, 2015

(30) Foreign Application Priority Data
Aug. 28, 2014 (DE) 102014217157.1

(51) Int. Cl. B23Q 7/14; B65G 47/248; B21B 15/00; B23P 23/04; B23C 3/13

(52) U.S. Cl. CPC B23Q 7/1468; B23Q 7/1421; B23P 23/04; B23C 3/13; B21B 15/00; B65G 47/248; B23C 2222/04

(57) ABSTRACT

A milling apparatus and method of milling aluminum ingots (30), wherein the milling apparatus (30) comprises a milling station (3) for milling the aluminum ingots (30) and a conveyor that transports the aluminum ingots (30) and that comprises one or more pallets (20) movable relative to the milling station (3) and designed to receive the aluminum ingots (30) to be milled and to transport these ingots through the milling station (3).

The invention relates to a milling apparatus for aluminum ingots, comprising at least one milling station for milling the aluminum ingots and a conveyor for transporting the aluminum ingots through the milling station, and to a method of milling these ingots.

Cold and hot rolling of aluminum ingots are well-known processes. The aluminum ingots must undergo a milling process—for example to remove casting skin and/or alloy inclusions—before forming by rolling, for example. Such a milling apparatus typically works at a very high performance level, for example, of 150 to 200 cm³/kW/min. They mill at very high speed.

The conventional approach is to move the aluminum ingots on roller conveyors. An apparatus that mills only one side, requires that the ingots be inverted in order to work them on two sides of the ingots one after the other in two processing steps.

The throughput of these milling apparatuses is limited due to the multistep processing, that is, the sequential milling of the two sides, but also by the handling of the ingots by the roller conveyors. Specifically, they bump up against the transport rollers as they are conveyed due to the geometry of the ingots. Increasing the transport speed thus results in subjecting the rollers and bearings, and in fact also the aluminum ingots themselves to high stress loads. For this reason, among others, it is not possible to simply increase the speed as desired avoid damaging the ingots.

One object of the invention is to provide a milling apparatus for aluminum ingots and a method of milling these ingots that allow milling to be performed with increased efficiency and/or higher quality and/or with less stress on the milling apparatus.

This object is attained by a milling apparatus having the features of claim 1 and by a method having the features of claim 12. Advantageous developments are found in the dependent claims, the following description of the invention, and in the description of the preferred embodiments.

The milling apparatus according to the invention comprises at least one milling station for milling the aluminum ingots and a conveyor to transport aluminum ingots. The term “ingots” is understood to refer primarily to square or parallepipedal blocks, however these also include geometries in general that allow for milling and preferably subsequent rolling. Aside from a milling station, it is obviously also possible to provide additional stations, for example, for measuring, aligning, quality controlling, and/or inverting the aluminum ingots. The conveyor functions to transport the aluminum ingots through various stations that are preferably stationary. The conveyor includes one or more movable pallets that are movable relative to the milling station and relative to any additional stations as necessary. The pallets are thus movable or slidable. Driving them can be effected either passively or actively. The preferable approach is to drive the pallets passively, i.e. the actual pallets do not have any drive means “on board” but are driven externally, for example, by rollers. Embodiments that are preferred in this regard are discussed below in more detail. Nevertheless the pallets can also be driven actively, for example by an electric motor provided on each pallet as well as by other means of transport. The pallets are designed to carry the aluminum ingots. Each pallet preferably carries one ingot. The aluminum ingots are thus clamped onto the pallets, attached thereto, secured, or otherwise gripped by the pallets upstream of the milling station (in the transport direction). Next the pallets together with the clamped ingots, irrespective of any other stations, pass through the milling station at which at least one surface of the aluminum ingots is milled. The miller can be implemented, for example, as an ingot miller with a large milling head and a considerable cutting capacity. The miller can be equipped with devices to aspirate or otherwise remove the chips. The milling apparatus preferably has a machine bed on which a shuttle is provided so as to be movable, the shuttle receiving and hydraulically clamping the aluminum ingot onto the respective pallet. The shuttle in this case is preferably designed for a high speed range.

The above-described pallet design allows the throughput performance of the milling apparatus to be increased and extremely high transport speeds to be attained. In addition, a high level of quality is achieved for the milled surfaces since the edges of the aluminum ingots are no longer damaged by roller marks. If the miller is a single-side miller, it is possible to achieve throughput performance rates that were previously possible only by using a double-sided miller. This approach furthermore achieves a higher level of quality for the milled surfaces since the edges of the aluminum ingots are no longer damaged by roller marks. Alternatively or in a combined approach, the potential for increasing throughput can also be utilized to reduce power consumption of the milling apparatus.

The pallets preferably run on rollers. The rollers can be rotatably attached to the pallets and run along a transport path, and/or the rollers can be provided in the transport path, where in this case the pallets are in contact with runners of the rollers. The transport path in this last case is provided essentially as a roller conveyor, and the rollers are not part of the pallets or are not attached to the pallets. The rollers can be arranged with substantially greater spacing as compared to a conventional roller conveyor on which the ingots move directly, i.e. without pallets. In overall terms this approach enables very much higher transport speeds to be run, an effect that can be enhanced even more by optimizing the running paths and/or the guide devices.

The milling apparatus preferably includes an inverting station for turning over the aluminum ingots. The inverting station is preferably equipped with tongs that grasp and invert the ingots. The milling apparatus preferably includes additional stations such as a measuring station upstream of the milling station, and/or a station for aligning the ingots. The milling apparatus is preferably designed to simultaneously effect transport and/or treatment, these terms being understood to include milling, inverting, aligning, inspecting, etc., of multiple aluminum ingots. The goal here is to enable many different work sequences to be performed in parallel in connection with or within the peripheral environment of milling. To express this differently: if a miller that cannot work all milling sides simultaneously is processing different sides of the ingot sequentially, the ingot must be inverted, and if necessary also re-measured and/or re-aligned as necessary. These actions are shifted to a parallel cycle. This then reduces down times before the next inversion of the conveyed items. This parallel processing enables milling times to be reduced, notwithstanding the sequential milling times that can otherwise be achieved only by a double-sided miller. As a result, the parallel processing described here simulates a double-sided miller. The pallet design described her is especially well-suited for these cycle-type systems both because the pallets can be operated at very high speed, thereby resulting in short reinvert times, and because the pallets provide a non-damaging means of transport.

In addition, variations in the throughput of different stations can be elegantly compensated out if the pallets can be controlled individually, i.e. their speeds can be adjusted individually at least in terms of certain operational segments. To accomplish this in either an alternative or supplemental approach, one or more transfer and/or buffer stations can be provided that receive and buffer one or more pallets. The milling station is preferably located upstream of the transfer station; the transfer station can be located, for example, upstream of the measuring station or can be integrated into this station.

The pallets preferably include conical supports on which the aluminum ingots must be clamped. Clamping is preferably effected in a central position to ensure they are conveyed reliably. Each pallet preferably includes an autonomous device for maintaining the clamping force, thereby ensuring that the pallets are reliable secured as they are conveyed through the different stations of the milling apparatus. The pallets are especially preferably provided with an identification device for automatic tracking of the pallet in the milling apparatus. Each identification device can include a memory holding various information, such as, for example, material properties, dimensions, and other properties relating to the clamped ingot. The identification device can, for example, be read by the stations of the milling apparatus and/or by a central controller. This allows for tracking and optional individual control of the pallets within the milling apparatus.

If an installation is equipped both with a milling apparatus to process aluminum ingots by a milling apparatus and as well as a rolling unit to roll the aluminum ingots milled by the milling apparatus, rolling is effected after milling. The pallet design described here is especially well-suited for these rolling mills with upstream milling.

This invention is used especially preferably in the technical area of processing aluminum ingots by rolling—however, the invention can also optionally be applied for use in other technical areas. In addition, other advantages and features of this invention are revealed in the following description of preferred embodiments. The features described here can be applied either individually, or in combination with one or more of the above-mentioned features as long as the features do not conflict with each other. The preferred embodiments are described below with reference to the attached drawing.

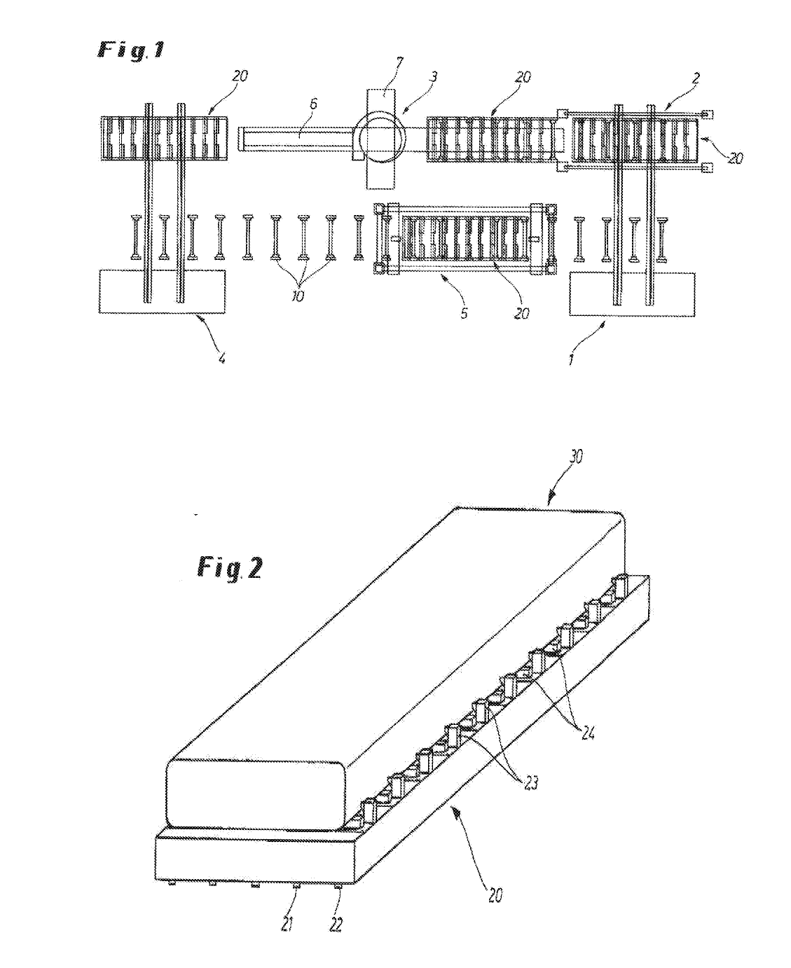

FIG. 1 is a schematic view of a milling apparatus having multiple stations.

FIG. 2 is a schematic view of a pallet to which an aluminum ingot is clamped.

Preferred embodiments are described below with reference to the figures. Elements that are similar or of similar function in the various figures are identified by identical reference numerals, and in part no repeat description of these elements is given so as to avoid redundancy.

FIG. 1 is a schematic view of a milling apparatus having an intake station 1, a measuring station 2, a milling station 3, an output station 4, and an inverting station 5. Stations 1, 2, 3, 4, 5 lie on an annular transport path that is equipped with appropriate transport means, here rollers 10, to transport pallets 20. FIG. 1 shows that multiple pallets 20 can be circulating simultaneously, thereby allowing for parallel treatment of the ingots (not shown in FIG. 1) that are carried by the pallets 20. An ingot 30 is shown by way of example in FIG. 2 that provides a three-dimensional schematic view of a pallet 20 and ingot 30.

The ingots 30 are first picked up at the intake station 1—for example, by an unillustrated factory crane or forklift. An empty pallet 20 is then fed in and put into circulation. The ingots 30 are each centered and lifted by an unillustrated transfer system and deposited on a respective one of the pallets 20. A cross transport unit moves the pallet 20 to the measuring station 2.

Other transfer stations, not identified here separately, can be positioned upstream or downstream of the individual stations 1, 2, 3, 4, 5 that can, for example, receive or buffer one or more the pallets 20, or at least transfer them to the next processing operation. A transfer station preferably positioned upstream of the milling station 3 can also be upstream of the measuring station 2 or can be integrated into this station. Combining the transfer and treatment stations is also possible for other operations (quality control, alignment, etc.).

The ingots 30 are measured in the measuring station 2. For example, the surface structure of the ingots 30 is measured and in particular the lowest point of the surface is determined, which aspect governs the amount of material that must be removed by milling.

A short travel distance downstream of the measuring station 2 leads to the milling station 3. This can include an ingot miller with shuttle. The ingot miller has a large milling head providing a high cutting performance, and also means to remove chips (for example by suction). A shuttle 7 runs along the machine table of the milling station 3—the table being identified at 6 in FIG. 1—which shuttle receives the pallet 20 and clamps it in place hydraulically. The shuttle 7 is designed to run at high speed.

Optionally, another transfer station (described above) can be downstream of the milling station 3. This transfer station downstream of the milling station 3 receives the pallet 20 together with the milled ingot 30 and allows the milled surface(s) to be inspected by an operator or by an automatic quality control system. In the event clearance is given by the system, either subsequent transport is effected for milling the second (next) side or for repeat milling of the first side, or the ingot 30 is sent to the output station 4.

FIG. 1 shows cross-transport of the pallet 20 to the output station 4. At the output station 4, the finished milled ingot 3 is lifted from the pallet 20 and if necessary from another conveyor for transfer to an ingot-storage unit, to a rolling mill, or made available to another device. The empty pallet 20 in this case is removed from circulation and made available again later at the intake station 1. Another possible approach, however, is one whereby further treatment of the ingots 30 following the completed milling operation is effected after discharge by the output station 4, again by the pallet transport system depicted here. In other words, the rolling unit, the ingot-storage unit, and/or other devices downstream of the milling apparatus or positioned upstream of it can also use the pallets 20 to transport the ingots 30. In this case the action of bringing the ingots 30 together with the pallets 20, or the separation therefrom, does not necessarily take place at the intake station 1 and the output station 4. In this case the intake station 1 and the output station 4 instead function as the input and output for the pallets 20 with the ingots 30 into and out of the milling apparatus.

If an ingot 30 remains in circulation after milling—for example, to again mill an insufficiently milled surface or to mill the second side (or in general another side), this pallet 20 next passes through the inverting station 5. This inverting station 5 uses ingot inverting tongs for turning over the ingot 30 as required. To accomplish this the inverting station 5 may be equipped with means for operating the clamping system of the pallets 20.

Downstream of the inverting station 5, the pallet 20 is fed in together with the clamped ingot 30 to another processing operation.

The milling apparatus described here is distinguished, among other aspects, by the fact that the transport system is designed as a circulating system. The ingots 30 are moved on the pallets 20. This enables supplemental tasks—in addition to the actual milling—to be performed during “nonproductive time,” i.e., in parallel, such as, for example, alignment, measurement, quality control, etc. As a result, throughput rates can be achieved that are otherwise attainable only by a double-sided miller.

FIG. 2 shows the pallet 20 in detail together with the clamped ingot 30. The ingot 30 rests on supports 24 that are preferably conical in shape. Clamps 23 are used to secure the ingot 30. The pallet 20 furthermore includes runners 22 on the pallet that function to guide and flawlessly transport the pallet 20 along the transport path. Additional means can 21 be provided to receive the pallet 20 in the system, for stabilization, to assist the drive, to hold the pallet 20, or the like.

The pallet 20 preferably clamps the ingot 30 in a central position. The pallet 20 is optionally equipped with an autonomous pressure-maintaining means or means for maintaining the clamping force so as to securely and reliably hold the ingots 30 in place. This means can be controlled externally at the intake station 1, the output station 4, or the inverting station 5. Each pallet 20 is preferably equipped with an identity code that is managed in the system for material tracking. This allows for later tracking of material data and the ingots 30.

To the extent these can find application, all individual features described in the illustrated embodiments can be combined and/or interchanged with leaving the scope of the invention.

Reference list

| | |
|---|---|
| 1 | intake station |
| 2 | measuring station |
| 3 | milling station |
| 4 | output station |
| 5 | inverting station |
| 6 | machine table |
| 7 | shuttle |
| 10 | rollers |
| 20 | pallet |
| 21 | machine adaptor |
| 22 | running surface |
| 23 | clamping device |
| 24 | ingot support |
| 30 | ingot |

1. A milling apparatus for aluminum ingots, the apparatus comprising:
at least one milling station for milling aluminum ingots and
a conveyor for transporting the aluminum ingots the conveyor having one or more pallets that can move relative to the milling station and that are designed to receive the aluminum ingots to be milled and to transport these ingots through the milling station.

2. The milling apparatus according to claim 1, wherein the pallets run on rollers.

3. The milling apparatus according to claim 2, wherein the conveyor includes a transport path that is provided with the rollers, and the pallets have runners in contact with the rollers when conveyed along the transport path, the pallets being advanced by one or more of the rollers.

4. The milling apparatus according to claim 1, wherein the milling apparatus includes an inverting station for turning over the aluminum ingots.

5. The milling apparatus according to claim 1, further comprising:
a measuring station upstream of the milling station.

6. The milling apparatus according to claim 1, wherein the conveyor is designed to effect simultaneous and/or parallel transport of multiple aluminum ingots.

7. The milling apparatus according to claim 1, wherein the milling apparatus is designed as a circulating system for parallel treatment of multiple ingots and for multiple treatments, preferably multiple milling actions performed on an ingot.

8. The milling apparatus according to claim 1, wherein one or more pallets have conical supports on which the aluminum ingots are clamped.

9. The milling apparatus according to claim 1, wherein one or more pallets is provided with an identification device to automatically track the pallet in the milling apparatus.

10. The milling apparatus according to claim 1, wherein one or more pallets includes an autonomous device for maintaining the clamping force.

11. An installation for processing aluminum ingots, comprising a milling apparatus according to claim 1 and a rolling unit to roll the aluminum ingots milled by the milling apparatus.

12. In a method of milling an aluminum ingot by a milling apparatus according to claim 1, the improvement comprising the steps of:
clamping the aluminum ingot onto one of the pallets before milling and
conveying the clamped ingot by the pallet through the milling station.
